(19) United States
(12) Patent Application Publication
(10) Pub. No.: US 2010/0220389 A1
(43) Pub. Date: Sep. 2, 2010

(54) POLYMERIC COVER WITH PROTECTIVE PROPERTIES AGAINST SOLAR RADIATION

(75) Inventors: Francisco Villuendas Yuste, Zaragoza (ES); Beatriz Garrido Arazola, Burjasot (ES); Carlos Heras Vila, Zaragoza (ES); Gerardo Hildalgo LLinas, Cartagena (ES)

Correspondence Address: SUGHRUE MION, PLLC, 2100 PENNSYLVANIA AVENUE, N.W., SUITE 800, WASHINGTON, DC, 20037, US

(73) Assignee: NOVOGENIO, S.L., Cartagena (ES)

(21) Appl. No.: 12/739,046

(22) PCT Filed: Oct. 6, 2008
(86) PCT No.: PCT/EP2008/063360

§ 371 Date: May 11, 2010

(30) Foreign Application Priority Data
Oct. 22, 2007 (ES) P 200702762

(51) Int. Cl. G02B 5/22; B32B 15/04; B32B 27/00; B32B 7/02; B32B 5/02; G02B 5/20; A01G 9/14; E04D 3/34; G02B 5/26

(52) U.S. Cl. 359/360; 428/457; 428/412; 428/469; 428/656; 428/447; 428/421; 428/413; 428/423.1; 428/216; 428/426; 359/359

(57) ABSTRACT

The invention relates to a cover polymeric with protective properties against solar radiation, suitable for controlling both ultraviolet radiation and infrared radiation or both at the same time. The cover comprises a substrate of polymeric material with a specific density greater than 1, provided with at least one UV radiation-absorbing compound: and at least one selective solar filter, transparent to visible light and reflecting infrared radiation, applied on said substrate and which is configured by at least one first dielectric material layer; at least one first metal layer; an intermediate layer as a barrier; and at least one second dielectric material layer. The cover is applicable as a coating of rigid laminar materials and also as material for greenhouses or buildings with transparent walls.

### TECHNICAL FIELD OF THE INVENTION

The present invention relates to a polymeric cover protecting against ultraviolet (UV) radiation and reflecting infrared radiation, which comprises a substrate of polymeric material with a specific density greater than 1, UV-blocking additives and at least one selective solar filter, transparent to visible light and reflecting infrared radiation, applied on said polymeric substrate.

The invention also relates to uses of said polymeric cover.

### BACKGROUND OF THE INVENTION

Plastic materials, due to their structural properties, are gradually managing to substitute other traditional materials with a metal or inorganic nature, such as glasses.

Plastic materials offer advantages over metals due to their “easy” mouldability, transformation, weight, maintenance and durability as they are not easily oxidizable. However, all are not advantages because they also have limitations typical of organic materials. Some of said limitations are: hardness, abrasion resistance, heat resistance and mechanical consistency. Recently and by means of processes for mixing different plastic materials, i.e., addition of additives or addition of mineral fillers such as fibreglass or carbon fibre, it has been possible to improve and achieve properties with which they equal, or even surpass traditional metal materials.

In relation to transparency, there are plastics that are as transparent as glass. They are amorphous polymers such as polymethylmethacrylate, polyethylene terephthalate and polycarbonate. These plastics have transmittance values similar to glass. Additives can easily be added to them and they can be easily coloured, they have a much lower weight (1.13 Kg/m2.mm of polycarbonate compared to 2.5 Kg/m2.mm of glass), they are less brittle, but on the other hand, they have a lower abrasion resistance. An attempt has been made to compensate this latter limitation by means of the use of surface coatings and treatments.

There are many applications in which, due to energy, practical or aesthetic reasons, it is necessary to have covers, roofs or enclosures which are transparent, such that they allow visible light to pass through. The traditional material par excellence for this application is glass, given its solar transmittance close to 90% and its mechanical characteristics, which makes it widely used for these applications. The development of transparent plastic materials has allowed these types of materials to be highly competitive with respect to traditional materials, given their physical and chemical characteristics: easy transformation, flexibility and adaptation and low weight. This is the case of skylights in department stores and residential buildings with which luminosity is provided to inner areas far from the side windows of the buildings and in which the low weight of the plastic materials allows reducing the support structure. This is also the case of agricultural greenhouses, in which the use of plastics on extremely lightweight structures allows considerably increasing the yield in quantity and quality of the crops.

As solar radiation is one of the environmental factors that are most difficult to control, particularly at latitudes above 25° from the equator, it is necessary to have solar radiation control systems. For example, at latitudes about 40°N, the radiation which is received at the surface in the month of December is approximately one third of that received in the month of June.

The use of plastic or glass materials for the construction of transparent enclosures involves, during the warm months of spring and summer and especially in warm and hot areas of the planet, a considerable increase of the temperature inside the compartment. This increase caused by solar radiation reaches values of about 1000 W/m² for a normal incidence. This situation forces making use of natural ventilation or air conditioning to reduce the temperature of the interior to comfortable or suitable values. The need to use air conditioning has the drawback of the high power consumption necessary to reduce the internal temperature and the economic cost associated thereto.

In the case of the films used in greenhouses, transparency is an extremely important quality in the radiation which is useful for plant growth and development. In this sense, it must be indicated that from the entire solar radiation spectrum, only one part of the radiation is considered as radiation useful for plant growth. Thus, the intensity of the radiation comprised between 400-700 nanometres, known as “Photosynthetically Active Radiation” (PAR), is the radiation which directly affects plant growth and development. The following table shows the percentages corresponding to each of the wavelength ranges of the total radiation incident on the Earth's surface:

TABLE 1

| Range | % |
|---|---|
| UV (280-400 nm) | 8.6-6.4 |
| PAR (400-700 nm) | 38.2-42.9 |
| FR (700-850 nm) | 16.5-15.2 |
| IR (850-2800 rim) | 33.9-34.2 |
| Thermal (>2800 nm) | 2.7-1.3 |

Solar radiation control has an added interest in the agricultural sector, in which transparent plastic materials have been widely used as coverings for horticultural and flower crops. In intensive agriculture processes under greenhouses and during summer, all plants suffer from heat stress, said stress causes a reduction of their growth and of their final yield. The following solutions are currently being used to control the radiation inside greenhouses: the use of films in which additives have especially been added, the vaporization of water therein, coating the outside of the greenhouses with whitewash, the use of meshes to create artificial shadows and forcing the aeration inside the greenhouse. These actions, in addition to not completely preventing the heat stress of plants, do not reduce the high water consumption due to the losses occurring because of the evaporation of water inside the greenhouse and because of the necessary ventilation thereof. In addition, during the time in which the greenhouses remain open to facilitate internal ventilation and aeration there is the possibility of unwanted insects penetrating therein, perniciously affecting the agricultural crops. On the other hand, in winter nights the temperature of the greenhouse decreases, mainly due to the temperature difference between day and night and to the high infrared transmission of the film. This temperature decrease makes it necessary to apply additional heating, with the subsequent energy cost.

The use of selective filters solves the aforementioned problems to a great extent. It reduces the temperature inside the compartment or the greenhouse. In the latter, the use of selective filters makes the evaporation of water decrease, it also decreases the need for ventilation and furthermore, mitigates the loss of nocturnal temperature inside the greenhouse.

In addition, ultraviolet radiation control inside the greenhouses can prevent or reduce the number of insects in the interior given that their field of vision is mainly in this area of the spectrum. Insect pests are currently combated by means of the use of insecticides or biological predators, with the subsequent productive cost increase and the decrease of the quality of the cultivated products. The use of insecticides, given the toxicity of these types of compounds, involves a risk for human consumption, and can seriously affect consumer health. The possibility of combating the pests by selecting the radiation inside the greenhouses by means of UV radiation filtration techniques is an advantageous and applicable alternative to transparent plastic materials, commonly used in the manufacture of covers for greenhouses as it detailed below.

The films which are currently used for the protection of greenhouses are films of polyethylene or polyethylene copolymers, preferably ethylene vinyl acetates (EVA). These types of plastic materials have a structural and mechanical consistency conditioned by the typical characteristics of these types of resins. They have a specific density less than 1, being less than those of technical or engineered plastic materials. Given the typical crystallinity of polyethylenes, the transmittance level in the visible area is less than 70-80%. In addition, they are materials with a turbidity of approximately 11%. Also, due to their molecular and optical properties, they are materials which are more transparent to IR radiation than technical plastics.

Other types of plastic resins with a better radiation transmission level than polyolefins and with a better structural consistency, such as multicellular polymethylmethacrylates and polycarbonates with a transmittance in the visible area of approximately 70-80%, have also been used for the construction of greenhouse structures. However, these materials, in addition to being more expensive than polyolefins, also have the drawback of an excessive environmental overheating occurring inside the compartments that they cover.

Taking into account all that has been set forth, in any type of enclosures, transmitted radiation control by means of the use of solar filters considerably improves the features of said enclosure.

For the purpose of controlling IR radiation, different types of organic and inorganic compounds have normally been added as additives to the polyolefins. Metal oxides in ratios ranging 0.5 and 15% are preferably used. This is the case of natural silicates (talc, kaolin, etc), synthetic silicates (zeolites), silica, calcium carbonate, barium sulphate, aluminium hydroxide, metal hydrosulphates, borax, metal borates, etc. Different plastics to which additives have been added have thus been patented, such as those described in Spanish patent ES 439227, U.S. Pat. No. 4,651,467 and U.S. Pat. No. 4,559,381 or in European patent documents EP 01541012 A1 and EP 0429731.

Nevertheless, the addition of these types of products to polyethylenes causes a series of drawbacks. For example, most of them must be added in large amounts (between 1-30%) to achieve a good opacity to infrared radiation. These compounds act as addition fillers of polyolefins, conditioning and reducing their mechanical properties and, what is more important, also reducing the total visible radiation transmission. The sheets with the longest duration which are currently being marketed in the agricultural sector assured a maximum durability of 3 years. In any case, there is a decrease of the transmission in the entire solar spectrum with very little visible-infrared selectivity, therefore the decrease of solar radiation is accompanied by a reduction of visible radiation.

A higher visible-infrared selectivity can be obtained, i.e., it can be achieved that the solar radiation control is carried out without reducing the visible transmission by means of the use of multilayer filters. Said filters contain transparent metal layers such that infrared radiation is reflected and visible radiation is transmitted. There are precedents on the use of filters on transparent substrates for reflecting infrared radiation such as the filter described in European patent EP 0454666B1. However, the filters described in said document are useful as sheets applicable for glazing. Said sheet is placed between two pieces of glass and has mechanical and durability properties which are not suitable for being used individually or independently, outside the actual glazing. Furthermore, the mentioned patent EP0454666B1 does not contemplate UV radiation control and its effect upon combining it with IR radiation control.

UV radiation is highly pernicious for human beings, triggering melanomas and skin carcinomas, among many other dermatological dysfunctions. Therefore, we must protect ourselves against this type of radiation in the hottest periods of summer. UV radiation is also harmful for plastic materials, because it decreases their durability and alters their mechanical properties. This is why many of them include UV stabilizers. These compounds are only added for the purpose of conserving the durability of these materials in external applications, the protection of human beings from the pernicious effects of this radiation being outside their objective. In this sense, the control of the pernicious effects of UV radiation in plastic materials for agriculture is carried out by means of adding any ultraviolet-absorbing compound as an additive in the polymeric mass. There are several known techniques for adding UV stabilizers as additives in plastic resins with the aim of improving their resistance to this type of radiation and, therefore, improving the durability of these materials. The simplest way is by means of the physical dispersion of UV additives in the resins, such that the UV stabilizers are trapped in the gaps of the polymeric chains (as is described in U.S. Pat. Nos. 4,325,863, 4,333,920). Another way is by means of the use of molecules containing reactive UV groups and furthermore capable of being co-polymerized during their manufacture (as is described in U.S. Pat. No. 4,055,714), the UV stabilizers being incorporated to the polymeric chains. A third option is by the reactive addition of UV stabilizers to oligomers or polymers to form branched copolymers with these compounds (as is described in U.S. Pat. Nos. 4,743,657 and 5,556,936).

Japanese patent JP9207262 A1 describes a sheet for agricultural uses capable of filtering IR radiation based on a solar filter formed by at least one layer of tin oxide. This same patent mentions that the sheet is transparent to UV radiation, only intercepting part of the infrared radiation. The resin used for the manufacture of said sheet is polyethylene terephthalate (PET) and it is provided that the latter contains a protective sheet based on a fluorinated resin or a type of silicone. In any case, the sheet detailed in Japanese patent application JP9207262 A1 is precisely focused on allowing the passage of UV radiation, facilitating therefore the visibility of insects inside the greenhouses in which this sheet is used. In addition, the sheets manufactured according to said patent have a very reduced visible-infrared selectivity.

Japanese patent application JP2000221322 A1 also describes an IR and UV filter, resulting from the combined effect of grouping multiple sheets with different refractive indices. These sheets, with high refractive indices, comprise at least one layer of an electrically conductive material formed by aluminium with zinc oxide and/or indium tin oxide (ITO). The combination of all the transparent sheets allows filtering IR and UV radiations, generated by a light source inside digital video equipment, but their applicability to large areas is very complicated because the number of layers involved is very high (in the order of 30 layers). Said combination does not have low emission properties either, because it has a far-infrared reflectance >3 μm, therefore its thermal performance is much lower.

For the moment, there is no type of laminar material or sheet transparent to visible light, with suitable mechanical, optical, chemical and environmental stability properties, which is applicable as a cover of roofs, walls or enclosures, on the agricultural market. Nor which can be directly used as a cover allowing the selective, simultaneous and combined control of the infrared radiation and the ultraviolet radiation at the same time. If this were so, it would prevent the heat excess inside the premises, it would decrease the risk of skin carcinomas in humans and insect attraction. There is also no plastic film which, exposed to the elements, has a durability greater than five years.

### DISCLOSURE OF THE INVENTION

The polymeric cover reflecting infrared radiation object of the present invention is designed to jointly control ultraviolet and infrared radiation.

The cover is essentially characterized in that it comprises:
a substrate of polymeric material with a specific density greater than 1, provided with at least one UV radiation-absorbing compound, selected from the group consisting of molecules with UV radiation-sensitive groups, said compounds being arranged inside the substrate of polymeric material or arranged in the form of a surface coating in another material comprising them; and
at least one selective solar filter, transparent for visible light and reflecting infrared radiation, applied on the aforementioned substrate and formed by at least one first dielectric material layer transparent to visible light, applied to said substrate; at least one first metal layer applied to the first dielectric material layer; an intermediate layer as a barrier, located on the metal layer and at least one second dielectric material layer, applied on the mentioned intermediate layer as a barrier.

In the present invention, UV radiation-absorbing compounds include molecules with UV radiation-sensitive groups, being able to be co-polymerizable with the material of the substrate, or molecules with UV radiation-sensitive groups suitable for reacting with oligomers or polymers to later form branched copolymers with these compounds.

In the context of the present invention, the term transparent means that it allows visible radiation transmission, unless otherwise indicated. Thus, the polymeric cover comprises a substrate of polymeric material and at least one selective solar filter which can be completely transparent, allowing clearly seeing the figures therethrough; or can have certain opacity or a translucent character, whereby the figures cannot be seen therethrough. In any case, it must be understood that visible light can traverse the assembly formed by the polymeric substrate and the selective solar filter by a percentage much greater than infrared transmission.

A polymeric material with a specific density greater than 1 refers to technical or engineered polymers.

According to another feature of the invention, the selective solar filter, transparent for visible light and reflecting infrared radiation, is formed by at least one first dielectric material layer transparent to visible light, applied to said substrate; at least one first metal layer, applied to the first dielectric material layer; an intermediate layer as a barrier, located on the metal layer; at least one second dielectric material layer, applied on the mentioned intermediate layer; at least one second metal layer, applied on the second dielectric layer; at least one intermediate layer located on the second metal layer, and at least one third dielectric layer, applied on the second intermediate layer as a barrier.

The cover object of the invention is also characterized in that it comprises at least one outer protective layer superimposed on the selective solar filter and/or on the free face of the substrate of polymeric material.

Said outer protective layer is preferably provided with at least one UV radiation-absorbing compound therein.

The control of the pernicious effects of ultraviolet radiation is carried out by means of a UV radiation absorption or reflection process caused by the deposition of metal oxides and metals in one or several suitably combined layers, applied on a part of or the entire planar surface of the cover.

The cover according to the invention is also characterized in that the substrate of polymeric material is indistinctly chosen from the group consisting of an acrylic polymer, a polyamide, a polyetherimide, a polycarbonate, a polyvinyl acetate, a polyethylene terephthalate, a polystyrene, a polyvinyl chloride or a polyacetal, copolymers thereof or a combination thereof obtained by extrusion processes.

According to another feature of the invention, the dielectric material layers comprise metal oxides and/or nitrides of metal elements, with a refractive index between 1.4 and 2.4.

The cover according to the invention is characterized in that the metal oxides are selected from the group consisting of tin oxides, zinc oxides, aluminium oxides, titanium oxides, silicon oxides, nickel oxides, or mixtures thereof.

In parallel, the cover according to the invention is characterized in that the nitrides of metal elements are selected from the group consisting of silicon nitrides and aluminium nitrides, or mixtures thereof.

The cover according to the invention is characterized in that the metal layers comprise a metal material selected from the group consisting of silver (Ag), gold (Au), aluminium (Al), chromium (Cr), copper (Cu), nickel (Ni) or an alloy thereof or mixture thereof.

In the context of the present invention, a metal alloy must be understood as any of the possible alloys which these metals can form with one another or with other metals.

The cover according to the invention is also characterized in that the selective solar filter comprises at least one intermediate layer, located between the metal layer or layers and the dielectric layer or layers subsequently applied on said metal layer or layers in the manufacturing process of said filter, which acts as a barrier during the mentioned manufacturing process and which is formed by at least one compound selected from the group consisting of titanium (Ti), chromium (Cr), nickel (Ni), nickel chromium alloys (NiCr) and indium tin oxides (ITO).

The cover according to the invention is characterized in that the outer protective layer of polymeric material is indistinctly chosen from the group consisting of an acrylic polymer, a polyamide, a polyetherimide, a polycarbonate, a polyvinyl acetate, a polyethylene terephthalate, a polystyrene, a polyvinyl chloride, a polysiloxane, or a polyacetal, or a copolymer of these resins.

Another option is that the outer protective layer of polymeric material is indistinctly chosen from the group consisting of a poly-alpha-olefin or copolymers of this poly-alpha-olefin with polyethylene (PE), polypropylene (PP), ethylene vinyl acetate (EVA), polyvinyl fluoride (PVF) or ethylene-vinyl alcohol (EVOH).

A cover is also preferred in which the outer protective layer of polymeric material is indistinctly chosen from the group consisting of epoxy resins, aliphatic or aromatic acrylic or urethane resins to which antioxidants and/or UV radiation-absorbing compounds have been added as additives.

According to another feature of the invention, the outer protective layer comprises several additives selected from antioxidant compounds and/or fluorescent compounds or polymers.

According to another feature of the invention, the thickness of each of the metal layers, each of the dielectric material layers and each of the intermediate layers is comprised between 5 and 500 nm.

The cover according to the invention is also characterized in that the polymeric substrate and/or the protective layer comprise the UV radiation-absorbing compound in a percentage by weight with respect to the total of said substrate of less than 10%.

Furthermore, according to the invention the polymeric substrate and/or the protective layer comprise several additives selected from antioxidant compounds and/or fluorescent compounds or polymers.

The cover according to the invention is characterized in that it has a transmittance of 0% to 70% at the wavelength of 290 nm in the ultraviolet region.

According to a preferred embodiment, the cover is characterized in that it further comprises an adhesive layer of polymeric material arranged between the outer protective layer and the contiguous dielectric material layer transparent to visible light on which it is applied.

Another object of the present invention is a cover characterized in that it comprises:
a substrate of polymeric material with a specific density greater than 1, provided with at least one UV radiation-absorbing compound; and
a selective solar filter, transparent for visible light and reflecting infrared radiation, applied on said transparent substrate and formed by a first dielectric material layer transparent to visible light applied to said substrate; a metal layer applied to the first dielectric material layer; an intermediate layer applied to the metal layer and formed by at least one compound selected from the group consisting of titanium (Ti), chromium (Cr), nickel (Ni), nickel chromium alloys (NiCr) and indium tin oxides (ITO); and a second dielectric material layer applied on the mentioned intermediate layer.

The presence of the outer protective layer is preferably provided on the last dielectric material layer of the selective solar filter and/or on the free face of the substrate of polymeric material.

Another preferred embodiment of the cover object of the invention comprises:
a substrate of polymeric material provided with at least one UV radiation-absorbing compound; and
at least two selective solar which are formed by a first dielectric material layer transparent to visible light, applied to said substrate; a first metal layer, applied to the first dielectric material layer; an intermediate layer as a barrier, located on the metal layer; a second dielectric material layer, applied on the mentioned intermediate layer; a second metal layer, applied on the second dielectric layer; a second intermediate layer located on the second metal layer, and a third dielectric layer, applied on the second intermediate layer as a barrier.

In the same way as in the other embodiment, the presence of the outer protective layer is provided on the last dielectric material layer of the selective solar filter and/or on the free face of the substrate of polymeric material.

The use of a cover for the construction of greenhouses or buildings with transparent walls and/or covers and/or roofs is also an object of the present invention.

Another object of the present invention is the use of a cover as a coating of rigid laminar materials selected from the group consisting of ceramic materials, plastics, glass, metal materials or a combination thereof.

### BRIEF DESCRIPTION OF THE DRAWINGS

For the purpose of illustrating the advantages and properties of the cover object of the present invention, several drawings showing different embodiments of the mentioned cover are set forth below and always by way of non-limiting examples:

FIG. 1 shows a diagram of the cross-section of a cover according to the invention, in which a transparent substrate and a selective solar filter including a metal layer can be seen;

FIG. 2 shows a diagram of the cross-section of a cover, also according to the invention, in which a transparent substrate and a selective solar filter including two metal layers can be seen;

FIG. 3 shows another embodiment of the cover object of the invention in which an outer protective layer joined to the selective solar filter by means of a layer of adhesive has further been added to the cover of FIG. 1;

FIG. 4 shows a cover according to FIG. 2 in which a selective solar filter including two metal layers and an outer protective layer joined to the selective solar filter by means of a layer of adhesive has been used;

FIG. 5 corresponds to a graph in which the y-axis shows the transmittance of a cover according to the invention with four layers according to the wavelength, the transmittance profile being compared with that of a cover of those commonly used in a greenhouse;

FIG. 6 corresponds to another graph in which the transmittance at different wavelengths of a cover with seven layers according to the invention is compared, comparing it with a conventional cover for greenhouses; and

FIG. 7 shows the difference of transmittances between a polymeric cover which is not provided with an outer protective layer and another polymeric cover to which an outer protective layer with a UV radiation-absorbing compound has been applied.

### DETAILED DESCRIPTION OF THE DRAWINGS

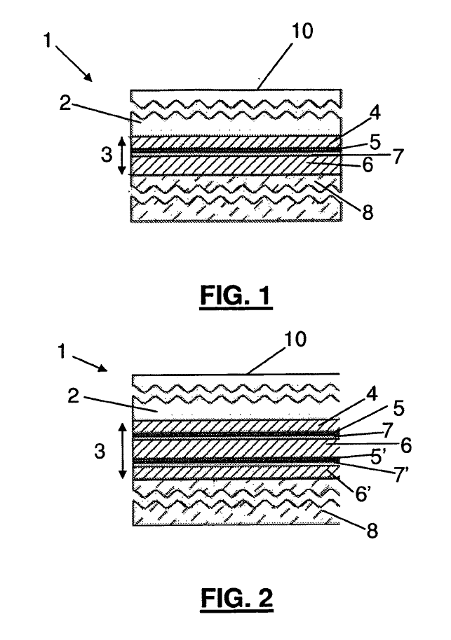

The polymeric cover 1 reflecting infrared radiation object of the invention, comprises, as can be deduced from FIGS. 1 to 4, at least one substrate 2 of transparent and polymeric material; and at least one selective solar filter 3.

The substrate 2 of transparent material is provided with at least one compound capable of absorbing ultraviolet UV radiation. As can be observed in Table 1, the UV radiation-absorbing compounds which are used in the cover 1 of the invention are radiation-sensitive compounds, being capable of co-polymerizing with the polymeric molecules with which the substrate 2 of transparent material is formed. Alternatively, molecules with UV radiation-sensitive groups or regions and which can react with oligomers or polymers to form branched co-polymers with the same are also used.

TABLE 2

| UV radiation absorbing molecule | Type of mechanism of action |
|---|---|
| 4-(4-t-butylazo-4-cyanovaleroxy)-2′- | Directly co-polymerizable with molecules |
| hydroxybenzophenone | integrating substrate 2 |
| di-(2-(2-hydroxybenzoyl)phenyl)cis-4,4- | Directly co-polymerizable with molecules |
| azobis(4-cyanovalerate) | integrating substrate 2 |
| di-(3-hydroxy-4-benzophenyl)trans-4,4′- | Directly co-polymerizable with molecules |
| azobis(4-cyanovalerate) | integrating substrate 2 |
| Benzophenone derivatives | Prior reaction with oligomers and/or |
| | polymers and subsequent formation of |
| | branched co-polymers |
| Benzothiazole derivatives | Prior reaction with oligomers and/or |
| | polymers and subsequent formation of |
| | branched co-polymers |

Depending on which molecule or molecules are used in the process for polymerizing substrate 2, the resulting cover 1 will be able to absorb the radiation in different ranges of wavelengths within the area of the electromagnetic radiation spectrum corresponding to ultraviolet (UV) radiation.

These molecules completely or partially absorb UV radiation and the combination thereof, inside the substrate 2 of transparent material, provides the desired properties, depending on what the final use of the polymeric cover 1 must be.

The selective solar filter 3 is in turn formed by at least one first dielectric material layer 4 transparent to the visible light, said first dielectric material layer 4 being applied to the substrate 2; at least one first metal layer 5 which is applied on the first dielectric material layer 4; and at least one second dielectric material layer 6, the latter being applied on the metal layer 5.

As is deduced from FIGS. 1 to 4, between the metal layer or layers 5, 5′ and the dielectric material layer or layers 6, 6′ subsequently applied on the contiguous metal layers 5, 5′ during the manufacturing process of the selective solar filter 3, there is arranged an intermediate layer 7, acting as a barrier precisely during said manufacturing process for the purpose of preventing the deterioration of the metal layers 5, 5′ while the dielectric material layers 6, 6′ are applied.

This intermediate layer 7 contains at least one compound selected from the group consisting of titanium, chromium, nickel, nickel chromium alloys and indium tin oxides (ITO). The thickness of the intermediate layer 7 is generally comprised between 5 and 20 nm.

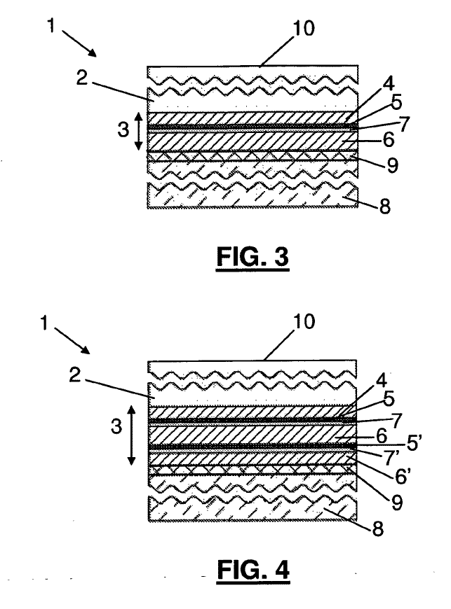

FIGS. 1 and 3 show specific embodiments of polymeric covers 1 according to the invention, in which a selective solar filter 3 with a single metal layer 5 located between a first dielectric material layer 4 transparent to visible light and an intermediate layer 7 followed by a second dielectric material layer 6 transparent to visible light has been arranged on a substrate 2 of transparent material.

Alternatively, FIGS. 2 and 4 show another embodiment of the transparent cover 1 object of the invention, where the selective solar filter 3 comprises two metal layers 5, 5′ located between respective dielectric material layers 4, 6, 6′ with intermediate layers 7, 7′ applied on the metal layers 5, 5′ before adding the respective dielectric material layers 6, 6′ subsequently added as additives during the manufacturing process of the selective solar filter 3.

The transparent substrates 2 correspond to polymeric materials such as a polymer acrylic, a polyamide, a polyetherimide, a polycarbonate, a polyvinyl acetate, a polyethylene terephthalate, a polystyrene, a polyvinyl chloride or a polyacetal. Substrates 2 formed by copolymers of the aforementioned compounds or substrates 2 which are a combination of two or more of them are also used.

These substrates 2 of transparent and polymeric material are obtained by coextrusion processes of the different materials forming them and the presence of a UV radiation-absorbing compound during the polymerization process has been provided in at least one of the polymers used.

The dielectric material layers 4, 4′, 6, 6′ have a refractive index comprised between 1.4 and 2.4. To that end, metal oxides and/or nitrides of metal elements, such as tin oxides, zinc oxides, aluminium oxides, titanium oxides, silicon oxides, nickel oxides, or mixtures thereof are used; as well as silicon nitrides and aluminium nitrides, or mixtures of them. These dielectric material layers 4, 4′, 6, 6′, which by definition are electrical insulators, are transparent to the visible light. The thickness of the dielectric material layers 4, 4′, 6, 6′ is comprised between 5 and 500 nm.

Silver (Ag), gold (Au), aluminium (Al), chromium (Cr), copper (Cu), nickel (Ni), a mixture of two or more of them or an alloy of said metals is used for the metal layers 5, 5′. These metal layers 5, 5′ have a thickness comprised between 5 and 100 nm.

Finally, for the purpose of preventing the environmental degradation of the selective solar filter 3 and to thus provide the entire assembly formed by the transparent substrate 2 and the selective solar filter 3 with a greater durability and best mechanical properties, the cover 1 can comprise an outer protective layer 8, also of polymeric material and which may or may not contain therein at least one UV radiation-absorbing compound.

The outer protective layer 8 is arranged contiguously to the last dielectric material layer 6, 6′ deposited during the manufacturing process of the cover 1 or directly on the free face 10 of the substrate 2, on the other side of selective solar filter 3, protecting the other face of the cover 1 against external abrasion, for example.

This outer protective layer 8 of polymeric material comprises at least one compound selected from an acrylic polymer, a polyamide, a polyetherimide, a polycarbonate, a polyvinyl acetate, a polyethylene terephthalate, a polystyrene, a polyvinyl chloride, or a polyacetal, or a copolymer of these resins.

Alternatively, the outer protective layer can be formed by a compound such as a poly-alpha-olefin or copolymers of this poly-alpha-olefin with polyethylene (PE), polypropylene (PP), ethylene vinyl acetate (EVA), polyvinyl fluoride (PVF) or ethylene-vinyl alcohol (EVOH)

Other compounds useful for forming the outer protective layer 8 are epoxy resins, aliphatic or aromatic acrylic or urethane resins, to which antioxidant or UV-absorbing compounds can be added as additives.

It is also provided that the protective layer 8 according to the invention comprises several additives of the antioxidant type and/or fluorescent substances (polymeric or non-polymeric), to control the radiation inside any compartment manufactured with said cover 1.

As is deduced from FIGS. 3 and 4, the cover 1 can comprise an adhesive layer 9, arranged in an intercalated manner between the outer protective layer 8 and the last dielectric material layer 6, 6′. Preferably, it is provided that said adhesive layer 9 also comprises at least one UV radiation-absorbing compound of the same nature as those used inside the substrate 2 of transparent polymeric material, and in the same ratio by weight, i.e., a percentage less than 10% by weight.

It is also provided that the cover 1 according to the invention comprises in the substrate 2 of transparent and polymeric material and/or in the outer protective layer, several additives of the antioxidant type and/or fluorescent substances (polymeric or non-polymeric), which serve to protect the materials from degradation by UV radiation and, in addition, to select the passage of solar radiation through the cover 1 and consequently, into any compartment manufactured with said cover 1.

Although it is not shown, another embodiment according to the invention provides that the substrate 2 of polymeric material comprises at its free face of the selective solar filter 3, another outer protective layer 8 or any surface coating, which will preferably comprise at least one UV radiation-absorbing compound. All this for the purpose of providing the entire assembly with a greater stiffness and/or making it more resistant to the wear by this radiation.

Some of the processes which can be used for the manufacture of the transparent polymeric cover 1 reflecting infrared radiation and absorbing ultraviolet radiation are described below for the purpose of facilitating the understanding of the invention.

Thus, to obtain the cover 1 of the invention, an operation is carried out such that on a substrate 2 of transparent and polymeric material, a first dielectric material layer 4 is added followed by the deposition of a first metal layer 5. An intermediate layer 7 as a barrier and formed by at least one compound selected from titanium, chromium, nickel, nickel chromium alloys and indium tin oxides (ITO) is added on said first metal layer 5 for the purpose of protecting it. Then, a second dielectric material layer 6 is deposited or added on said intermediate layer 7. At this point, if the cover 1 must have only one metal layer, the latter is already for their use as a finished product. However, if the cover 1 is intended to be used exposed to the elements, it is convenient to add an outer protective layer 8 as has been previously described on the second dielectric material layer 6.

A process for depositing metals and/or dielectric compounds, such as chemical vapour deposition (CVD) or the physical vapour deposition (PVD) is mainly used for the successive addition of the different layers 4, 5, 6, 7, 8 to the transparent substrate 2. The “magnetron sputtering” technique is preferably chosen within the PVD techniques.

In relation to the outer protective layer 8, the latter can be added by lamination by means of the intercalation of an adhesive layer 9 with a nature as has been previously described. If said outer protective layer 8 is added by lamination, an adhesive layer 9 is used and it is adhered by a process called hot melt. The outer protective layer 8 can also be adhered to the last dielectric material layer 6, 6′ by means of a adhesive activated by heat or by UV radiation.

If the outer protective layer 8 is made of epoxy resins, aliphatic or aromatic acrylic or urethane resins, then it can be added by means of volatilization or “spray” techniques or by means of a roller, and said resins subsequently being activated by heat and/or by UV radiation.

Depending on the number of metal layers 5, 5′ which must be contained by the selective solar filter 3 which is added to the substrate 2 of transparent and polymeric material to form the cover 1 according to the invention, the steps of addition of metal layer 5, 5′, followed by addition of intermediate layer 7, 7′ and dielectric material layer 6, 6′ occur progressively until the last metal layer 5′ is deposited, which layer is covered with the last dielectric material layer 6′.

Evidently, there may be variants of the described process known by the person skilled in the art, which variants will depend on the materials used and the uses of the transparent covers 1 which are obtained.

Some examples of covers 1 according to the invention are presented, as well as their transmittance properties at the different wavelengths are set forth below. Said examples allow viewing the properties of the covers 1 in relation to the homologous covers or structures of the state of the art.

### Example 1

### Multilayer Transparent Polymeric Cover 1 with a Selective Solar Filter with Four Layers

A selective solar filter 3 of those comprising dielectric material layers 4, 6, 6′ with tin oxide, with thicknesses of 25 nm and 50 nm and one silver metal layer 5 with a thickness of 15 nm and a Ti intermediate layer 7 as a barrier and with a thickness of 2 nm is added or constructed with the “magnetron sputtering” technique on a film or substrate 2 of polycarbonate (PC) transparent material comprising therein a benzophenone derivative as a UV radiation absorbent, in a percentage by weight of 5%.

A spectroscopic study of cover 1 of Example 1 is conducted for the purpose of determining the visible/infrared selectivity and the UV radiation transmission capacity and at the same time the transmittance at the different wavelengths of the cover of Example 1 is compared with the transmittance of a conventional film for greenhouses.

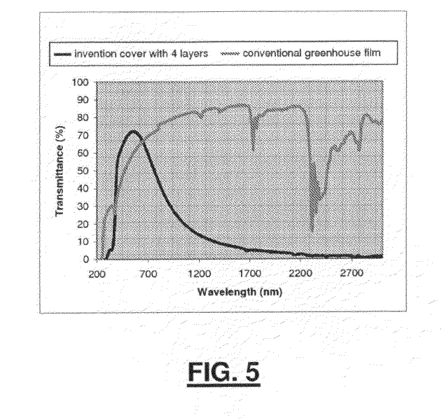

The behaviour of the cover 1 of Example 1 and that of the conventional film can be seen in FIG. 5. The dark thick line corresponds to the transmittance percentage of a cover 1 with four metal layers 5. The cover 1 has low transmittance percentages in the region of the wavelengths of the area of the spectrum corresponding to UV radiation (from 200 to 400 nm), which allows stating that UV radiation does not penetrate through the cover, or will do so in a very low percentage. With regard to the wavelengths of the spectrum corresponding to visible light (from 400 to 800 nm), the cover 1 of Example 1 has a transmittance of 50% to 70%, which assures good visibility through such cover. With regard to the area of the electromagnetic radiation spectrum corresponding to infrared radiations (from 800 to 3000 nm), causing the heating, it can be observed that the transmittance of the cover 1 according to the invention falls abruptly in relation to that of visible light, being less than 2%.

Comparatively, the films conventionally used in greenhouses, which use can also be given to the cover 1 object of the invention, allow the passage of light by a higher percentage in the area of the UV spectrum and also in the area of the spectrum corresponding to infrared radiation (light thick line of FIG. 5). Therefore, the interpretation which must be made, as is already known, is that these types of films allow the passage of both UV and IR radiation, favouring the entrance of insects and pests into the greenhouses and increasing the heat therein during the day, due to the effect of IR radiation.

Another effect occurring in the cover 1 of said example and, generally in the polymeric covers 1 according to the invention can also be observed in this FIG. 5, and this effect is that they have a higher transmittance in the visible area than that of conventional films for greenhouses, making them optimal for this application, and even suitable for transparent enclosures or covers.

### Example 2

### Multilayer Transparent Polymeric Cover 1 with a Selective Solar Filter with Seven Layers

A selective solar filter 3 of those comprising dielectric material layers 4, 6, 6′ with tin oxide, with thicknesses of 30 nm, 80 nm and 35 nm respectively and two silver metal layer 5 with a thickness of 10 nm and 12 nm respectively and two titanium barrier layers with a thickness of 2 nm is added or constructed with the “magnetron sputtering” technique on a film or substrate 2 of polycarbonate (PC) transparent material comprising therein a benzophenone derivative as a UV radiation absorbent, in a percentage by weight of 5%.

In the same way as in Example 1, the visible/infrared selectivity and the UV radiation transmission capacity were also studied, and the data obtained was compared with a conventional film for greenhouses.

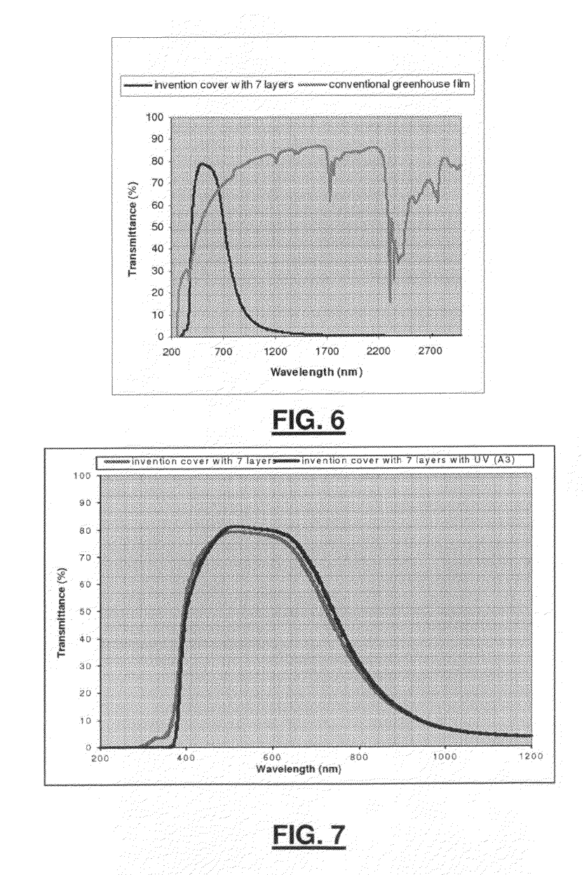

The transmittance of a cover 1 with seven layers (between dielectric material layers 4, 6, intermediate layers 7 as a barrier, and metal layers 5 according to the radiation wavelength) can be seen with a dark thick line in FIG. 6. As in Example 1, the transmittance is maximum in the visible area of the spectrum, whereas it is virtually nil in the areas of the spectrum corresponding to UV and IR radiation.

Furthermore, the passage of the radiation through the cover 1 in the area of the visible spectrum is higher than the equivalent one for a conventional greenhouse film.

If the data shown in FIGS. 5 and 6 is compared, it can be observed that there is a higher visible/infrared selectivity with the materials used for the covers 1 of Examples 1 and 2, in the structure with two silver metal layers 5, 5. In other words, visible transmission and infrared reflection increase simultaneously due to the interference conditions occurring in the different layers.

### Example 3

### Multilayer Transparent Polymeric Cover 1 with a Selective Solar Filter with Seven Layers and an Acrylic Protective Layer with UV Additive

Another acrylic film as an outer protective layer was added on a transparent polymeric cover 1 prepared as described in Example 2. The protective film used was a butyl-methyl methacrylate copolymer (CAS 256018-33-7) supplied by Aldrich, containing 3% Tinuvin 360 (UV stabilizer).

The difference of transmittances of a transparent cover 1 without an outer protective layer 8 (light line) and another cover with an applied outer protective layer 8 and with a UV additive (dark line) can be seen in FIG. 7.

In comparative terms, FIG. 7 shows the difference of transmittance between both covers 1. The cover 1 provided with an outer protective layer 8 has transmittance values close to zero in the UV region (280-400 nm).

With these examples, it is demonstrated that the covers 1 object of the invention are excellent heat barriers, being capable of reflecting IR radiation which, as it is not absorbed, is not re-emitted into the cover 1.

The polymeric covers 1 object of the invention can be used as a coating of rigid laminar materials, such as glass for construction, glass for automobiles, plastics which must be protected from certain radiations, as well as ceramic or metal materials, for which a certain durability is to be to ensured.

One of the more suitable uses of the cover 1 object of the invention is its direct use in the construction of greenhouses or buildings with transparent walls and/or roofs and/or covers.

Thus, with the object of the present invention novel materials are provided with mechanical, optical, chemical and environmental stability properties suitable for their use as covers and roofs of greenhouses with a long duration, even greater than 3 years (the current maximum duration of the covers of current greenhouses constructed by polyolefins). The joint use of solar filters 3 and ultraviolet radiation-absorbing compounds has other advantages, in addition to the mentioned advantages. On one hand, the use of solar filters 3 with a suitable design carries out a certain ultraviolet radiation control, allowing a lower concentration of the blocking additives used up until now. On the other hand, these selective solar filters 3, due to their infrared-reflecting characteristics, prevent the inner-outer far-infrared transmission, reducing the energy losses of the greenhouse in cold winter nights of, and therefore reducing the heating needs.

With the cover 1 object of the invention, covers or enclosures can be provides with a minimum light transmittance which is in accordance with the required application, greater than 50% and less than 90%; a solar (visible) transmission between 50% and 75% of light transmission, a transmission in UV less than 3% and a transmission in thermal IR less than 2%. At the same time, it is assured that the covers and/or enclosures have a durability greater than 5 years in conditions of exposure to the elements.

1. A polymeric cover (1) with protective properties against solar radiation, suitable for jointly controlling ultraviolet and infrared comprising:
a substrate (2) of polymeric material with a specific density greater than 1, provided with at least one UV radiation-absorbing compound, selected from the group consisting of molecules with UV radiation-sensitive groups, said UV radiation-absorbing compounds being arranged inside the substrate of polymeric material or in the form of a surface coating in another material comprising them; and
at least one selective solar filter (3), transparent for visible light and reflecting infrared radiation, applied on said substrate and formed by at least one first dielectric material layer (4) transparent to visible light, applied to said substrate; at least one first metal layer (5) applied to the first dielectric material layer; an intermediate layer (7) as a barrier, located on the metal layer and at least one second dielectric material layer (6), applied on the mentioned barrier layer.

2. The polymeric cover (1) according to claim 1, wherein the selective solar filter (3) further comprises at least one second metal layer (5′), applied on the second dielectric material layer (6); at least one second intermediate layer (7′) located on the second metal layer, and at least one third dielectric layer (6′), applied on the second intermediate layer as a barrier.

3. The polymeric cover (1) according to claim 1, further comprising at least one outer protective layer (8) superimposed to the selective solar filter and/or to the free face (10) of the substrate (2) of polymeric material.

4. The polymeric cover (1) according to claim 3, wherein the outer protective layer (8) of polymeric material is provided therein with at least one UV radiation-absorbing compound or contains one or several surface metal and metal oxide layers capable of absorbing or reflecting all or part of the UV radiation.

5. The polymeric cover (1) according to claim 1, wherein the substrate (2) of polymeric material is independently chosen from the group consisting of an acrylic polymer, a polyamide, a polyetherimide, a polycarbonate, a polyvinyl acetate, a polyethylene terephthalate, a polystyrene, a polyvinyl chloride or a polyacetal, copolymers thereof or a combination thereof obtained by extrusion processes.

6. The polymeric cover (1) according to claim 1, wherein one or several of the dielectric material layers (4, 6) comprise metal oxides and/or nitrides of metal elements, with a refractive index between 1.4 and 2.4.

7. The polymeric cover (1) according to claim 6, wherein the dielectric materials are metal oxides selected from the group consisting of tin oxides, zinc oxides, aluminium oxides, titanium oxides, silicon oxides, nickel oxides, or mixtures thereof, or nitrides of metal elements selected from the group consisting of silicon nitrides and aluminium nitrides, or mixtures thereof.

8. The polymeric cover (1) according to claim 1, wherein one or several of the metal layers (5, 5′) comprise a metal material selected from the group consisting of silver (Ag), gold (Au), aluminium (Al), chromium (Cr), copper (Cu), nickel (Ni) or an alloy thereof or mixture thereof.

9. The polymeric cover (1) according to claim 1, wherein one or several of the intermediate layers (7, 7′) as a barrier comprise a material selected from the group consisting of titanium (Ti), chromium (Cr), nickel (Ni), nickel chromium alloys (NiCr) and indium tin oxides (ITO).

10. The polymeric cover (1) according to claim 3, wherein the outer protective layer (8) of polymeric material is independently chosen from the group consisting of an acrylic polymer, a polyamide, a polyetherimide, a polycarbonate, a polyvinyl acetate, a polyethylene terephthalate, a polystyrene, a polyvinyl chloride, a polysiloxane, or a polyacetal, or a copolymer of these resins.

11. The polymeric cover (1) according to claim 3, wherein the outer protective layer (8) of polymeric material is independently chosen from the group consisting of a poly-alpha-olefin or copolymers of this poly-alpha-olefin with polyethylene (PE), polypropylene (PP), ethylene vinyl acetate (EVA), polyvinyl fluoride (PVF) or ethylene-vinyl alcohol (EVOH).

12. The polymeric cover (1) according to claim 3, wherein the outer protective layer (8) of polymeric material is independently chosen from the group consisting of epoxy resins, aliphatic or aromatic acrylic or urethane resins to which UV radiation-stabilizing compounds have been added as additives.

13. The polymeric cover (1) according to claim 3, wherein the outer protective layer (8) further comprises several additives selected from antioxidant compounds and/or fluorescent compounds or polymers.

14. The polymeric cover (1) according to claim 1, wherein the thickness of each of the metal layers (5, 5′), each of the dielectric material layers (4, 6) and each of the intermediate layers (7, 7′) is comprised between 5 and 500 nm.

15. The polymeric cover (1) according to claim 1, wherein the substrate (2) of polymeric material and/or the outer protective layer (8) comprises the UV radiation-absorbing compound in a percentage by weight with respect to the total of said substrate less than 10%.

16. The polymeric cover (1) according to claim 1, wherein the substrate (2) further comprises several additives selected from antioxidant compounds and/or fluorescent compounds or polymers.

17. The polymeric cover (1) according to claim 1, having a transmittance of 0% to 70% at the wavelength of 290 nm in the ultraviolet region.

18. The polymeric cover (1) according to claim 3, comprising an adhesive layer (9) of polymeric material arranged between the outer protective layer (8) and the contiguous dielectric material layer (6) transparent to visible light.

19. A polymeric cover (1) comprising:
a substrate (2) of polymeric material with a specific density greater than 1, provided with at least one UV radiation-absorbing compound; and
a selective solar filter (3), transparent for visible light and reflecting infrared radiation, applied on said substrate and formed by a first dielectric material layer (4) transparent to visible light, applied to said substrate; a metal layer
(5) applied to the first dielectric material layer; an intermediate layer (7) applied to the metal layer and formed by at least one compound selected from the group consisting of titanium (Ti), chromium (Cr), nickel (Ni), nickel chromium alloys (NiCr) and indium tin oxides (ITO); and a second dielectric material layer (6) applied on the intermediate layer.

20. The polymeric cover (1) according to claim 19, comprising:
a substrate (2) of polymeric material provided with at least one UV radiation-absorbing compound; and
at least two selective solar filters (3-3′) which are formed by a first dielectric material layer (4) transparent to visible light, applied to said substrate; a first metal layer (5), applied to the first dielectric material layer; an intermediate layer (7) as a barrier, located on the metal layer; a second dielectric material layer (6), applied on the mentioned intermediate layer; a second metal layer (5′), applied on the second dielectric layer; a second intermediate layer (7′) located on the second metal layer, and a third dielectric layer (6′), applied on the second intermediate layer as a barrier.

21. The polymeric cover (1) according to claim 19, further comprising at least one outer protective layer (8) superimposed to the selective solar filter or filters and/or to the free face (10) of the substrate (2) of polymeric material.

22. The use of a polymeric cover (1) according to claim 1 as a coating of rigid laminar materials selected from the group consisting of ceramic materials, plastics, glass, metal materials or a combination thereof.

23. The use of a transparent cover (1) according to claim 1 for the construction of greenhouses or buildings with transparent walls and/or roofs and/or covers.
